(19) United States
(12) Patent Application Publication
(10) Pub. No.: US 2005/0071302 A1
(43) Pub. Date: Mar. 31, 2005

(54) Method and system for mapping genes to characteristics in a genetic optimization process

(76) Inventors: Tyson R. McGuffin, Fort Collins, CO (US); Thomas W. Chen, Fort Collins, CO (US); Dave Anderson, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/675,883

(22) Filed: Sep. 29, 2003

(51) Int. Cl. G06N 3/12; G06F 15/18; G06N 3/00

(52) U.S. Cl. 706/13

(57) ABSTRACT

The iterations required for the convergence of a computer-implemented optimization process based on a genetic model are reduced, and the flexibility of the process is increased through mapping multiple characteristics of a system to be optimized to a single gene within a chromosome.

### FIELD OF THE INVENTION

The present invention relates generally to computerized optimization techniques and more specifically to techniques based on a genetic model.

### BACKGROUND OF THE INVENTION

Due to the large number of variables involved, some optimization problems have an exceedingly large solution space. For example, selecting design parameters such as size for each of thousands of instances (occurrences of cells) in an integrated circuit to minimize power consumption while maintaining acceptable timing performance is such a problem.

One approach to solving complex optimization problems is genetic optimization, an iterative, computer-implemented technique in which candidate solutions are generated using a genetic model. The genetic model typically includes a set of N randomly generated chromosomes, each chromosome comprising a number of genes. Since each gene represents a particular state of a characteristic to be optimized in one part of a system (e.g., the width of a particular transistor in an integrated circuit), each chromosome represents a possible solution to the global optimization problem. In a typical application, the configuration specified by each chromosome is evaluated, and a fitness score is assigned to each chromosome. For example, in the case of an integrated circuit design, circuits having the characteristics of each respective chromosome may be simulated to assign a fitness score to each based on its power consumption and timing performance. Once each chromosome has been assigned a score, the N chromosomes may be “mated” or “mutated” in various ways to create other potential solutions or “children,” which may, in turn, be evaluated and assigned a fitness score. Each pass through this reproduction procedure may be termed a “generation” of the genetic optimization process. If a child has a higher score than one of the original N chromosomes, the chromosome with the lowest score may be discarded. Eventually, the candidate solutions generated in this fashion may converge to the global optimum. This approach to optimization essentially exploits the principle of natural selection.

Since each gene corresponds to a single characteristic of the system to be optimized, the size of the chromosome may become extremely large for complex systems, slowing convergence. Also, particular aspects of a system may be improved if they are designed somewhat deterministically instead of purely by random trial and error. For example, an integrated circuit designer may know that the width of two transistors in the circuit should be related by a particular ratio. If the width characteristic of each transistor is mapped to a separate, independent gene, however, the desired size relationship is unlikely to be realized.

It is thus apparent that there is a need in the art for an improved method and system for mapping genes to characteristics in a genetic optimization process.

### SUMMARY OF THE INVENTION

A method is provided for mapping genes to characteristics in a computer-implemented genetic optimization process. A system and a computer-readable storage medium for carrying out the method are also provided.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIGS. 1A-1C are illustrations showing how the characteristics of an integrated circuit may be mapped onto a genetic algorithm in accordance with an illustrative embodiment of the invention.

FIG. 2 is an overview flowchart of a genetic optimization process in accordance with an illustrative embodiment of the invention.

FIG. 3A is an illustration of a situation in which it is desirable to set a characteristic for each of a set of instances in an integrated circuit to a common value in accordance with an illustrative embodiment of the invention.

FIG. 3B is an illustration of a situation in which it is desirable to ensure a predetermined size ratio among instances in an integrated circuit in accordance with an illustrative embodiment of the invention.

FIG. 3C is an illustration of another situation in which it is desirable to ensure a predetermined size ratio among instances in an integrated circuit in accordance with an illustrative embodiment of the invention.

FIG. 4 is a flowchart of a method for setting, in a computer-implemented optimization process, a characteristic of the system to be optimized in accordance with an illustrative embodiment of the invention.

FIG. 5A is an illustration of an entry in a data structure that maps genes in a chromosome to characteristics of a system to be optimized in accordance with an illustrative embodiment of the invention.

FIG. 5B is an illustration of a data structure comprising multiple entries that maps genes in a chromosome to characteristics of a system to be optimized in accordance with an illustrative embodiment of the invention.

FIG. 6 is an illustration of a system for carrying out the methods of the invention in accordance with an illustrative embodiment of the invention.

FIG. 7 is a flowchart of the operation of the system shown in FIG. 6 in accordance with an illustrative embodiment of the invention.

### DETAILED DESCRIPTION OF THE INVENTION

The number of genes per chromosome may be reduced by mapping multiple characteristics to a single gene. Although the embodiments discussed concern the optimization of integrated circuits, the principles of the invention may be applied to any genetic optimization process.

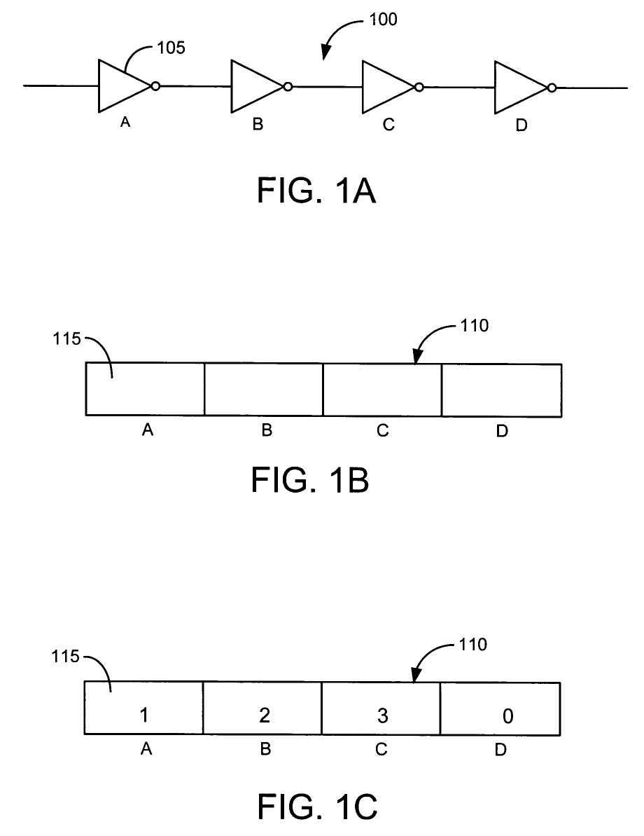

FIGS. 1A-1C illustrate how, in general, the characteristics of an integrated circuit may be mapped onto a genetic optimization process in accordance with an illustrative embodiment of the invention. FIG. 1A is a gate-level diagram of a simple integrated circuit 100. In this simplified example, integrated circuit 100 comprises four instances (replications of a cell) 105, each of which is an inverter. Each instance 105 is labeled A-D to clarify the relationships among the three figures. Since there are typically multiple design choices (size, cell type, transistor model, etc.) associated with each instance 105, throughout this description each such design choice will be called a “characteristic” of integrated circuit 100. An alternative term that is sometimes used in the art is “implication,” since each design choice (e.g., choice of parameter) implies a corresponding effect on the ultimate performance of integrated circuit 100.

FIG. 1B is a conceptual diagram of a chromosome 110 comprising four genes 115. Genes 115 may be represented conveniently as integers, for example. In this simple example, each gene 115 maps to a single characteristic of a unique one of the four instances 105 (A-D) in integrated circuit 100. For example, each gene 115 may indicate the size of its corresponding instance 105. In later portions of this description, it will be explained how multiple characteristics associated with one or more instances 105 may be mapped to a single gene 115. An example of a particular chromosome conforming to the foregoing scheme is shown in FIG. 1C.

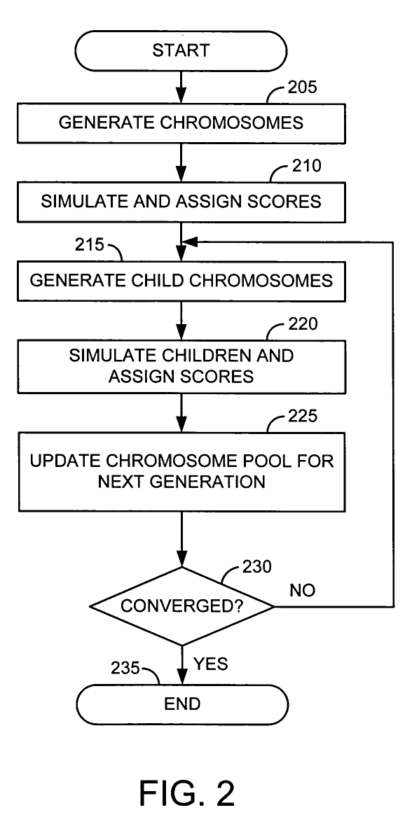

FIG. 2 is an overview flowchart of a genetic optimization process in accordance with an illustrative embodiment of the invention. At 205, a set of N unique chromosomes 110 may be generated. For example, a random number generator may be used to assign a value to each gene 115 in each of the N chromosomes 110. The set of N chromosomes 110 will also be referred to as a “chromosome pool” in this description. In practice, the values generated by the random number generator may be pseudorandom. The performance of integrated circuits 100 having design characteristics corresponding to each of the respective N chromosomes 110 may be simulated at 210. In this illustrative embodiment, the power consumption of integrated circuit 100 is to be minimized while maintaining acceptable timing. At 210, a fitness score may be assigned to each chromosome indicating how well it meets the design goals. For example, the score may be a number proportional to the total power consumption of integrated circuit 100. At 215, a set of “child chromosomes” is generated through a reproduction process (e.g., mating and/or mutation). At 220, integrated circuits 100 corresponding to the child chromosomes are simulated, and a fitness score is assigned to each child chromosome. The fitness scores of the child chromosomes are evaluated at 225, and the chromosome pool is updated for the next generation at 225. For example, the best N chromosomes from among the original N and the child chromosomes may be retained for the next generation. The foregoing process repeats until convergence to a solution occurs at 230, at which point the process may terminate at 235.

The most time-consuming aspect of the genetic optimization process shown in FIG. 2 is typically simulating the trial integrated circuits 100 corresponding to the various chromosomes to obtain their associated fitness scores. Even if each chromosome is evaluated by a separate processing node in a network of processing nodes (parallel processing), the time required to complete a generation can be significant, leading to long convergence times. The present invention improves the speed and efficiency of the process by reducing the number of iterations required for convergence and by providing greater control over the characteristics of related instances 105.

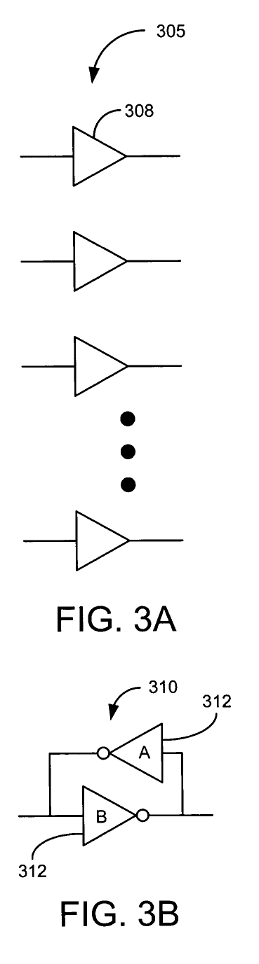

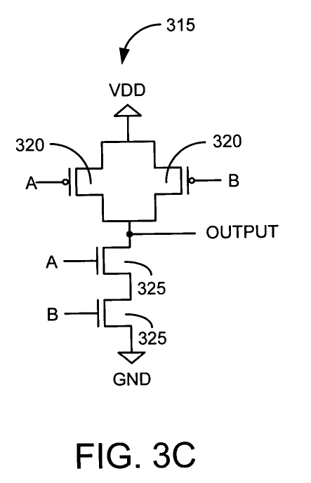

FIGS. 3A-3C are examples of situations in which a circuit designer may desire to constrain particular characteristics of an integrated circuit to conform to a deterministic scheme instead of allowing a genetic optimization process to set those characteristics freely. The present invention facilitates such control over the characteristics of related instances 105, as will be explained in a later portion of this description.

FIG. 3A is an illustration of a set of buffers 308 (each of which is an instance 105) in a data bus 305. Since each buffer 308 performs an identical function in its corresponding bus line, a circuit designer typically desires all buffers 308 in data bus 305 to be identical (e.g., the same size). In such a situation, it is desirable to group the buffers 308 (instances 105) and map their common characteristics to a single gene. How this may be done will be explained in a later portion of this description.

FIG. 3B is an illustration of a portion of a latch 310 comprising two inverters 312 (each of which is an instance 105) labeled “A” and “B.” In this situation, a circuit designer typically desires inverter “A” to be smaller (perhaps by a factor of two or three) than inverter “B.” For example, the designer may have determined an optimum size ratio for the application for which the integrated circuit is intended.

FIG. 3C is an illustration of a CMOS NAND gate 315 comprising PMOS transistors 320 and NMOS transistors 325. In this situation, a circuit designer typically desires PMOS transistors 320 to be somewhat larger than NMOS transistors 325 (e.g., a ratio of 2:1).

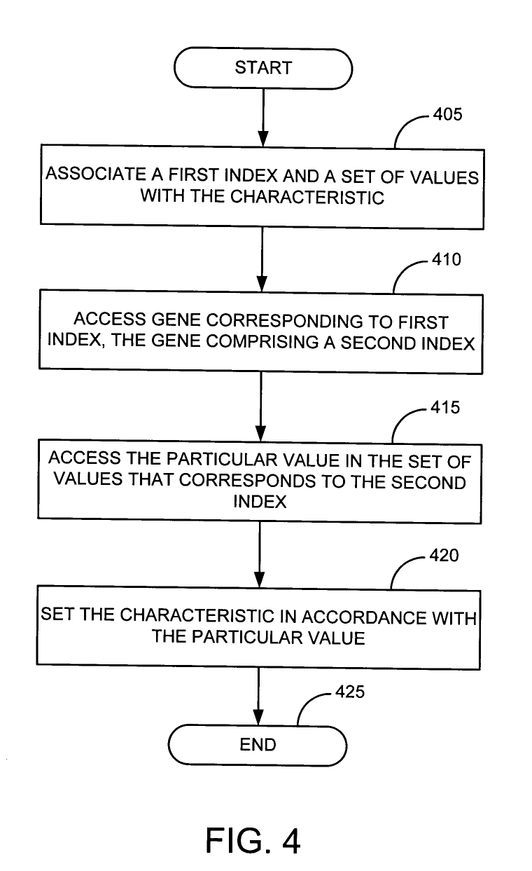

FIG. 4 is a flowchart of a method for setting, in a computer-implemented optimization process, a characteristic of a system to be optimized in accordance with an illustrative embodiment of the invention. The method of FIG. 4 is based on a double indexing scheme. At 405, a first index and a set of values are associated with the characteristic. The set of values comprises the set of possible values to which the characteristic may be set during evaluation (e.g., simulation) of a system having the characteristics specified by a chromosome 110. At 410, the gene 115 in chromosome 110 to which the first index points is accessed. For example, the genes 115 in chromosome 110 may be numbered from 0 to M-1, where M is the number of genes 115 in chromosome 110. The first index may, in this example, be an integer from 0 to M-1, inclusive. Furthermore, gene 115 may itself comprise a second index that points to a particular value in the set of values associated with the characteristic. This particular value is accessed at 415. At 420, the characteristic may be set to the particular value obtained in step 415. The process terminates at 425 and may be repeated for other characteristics.

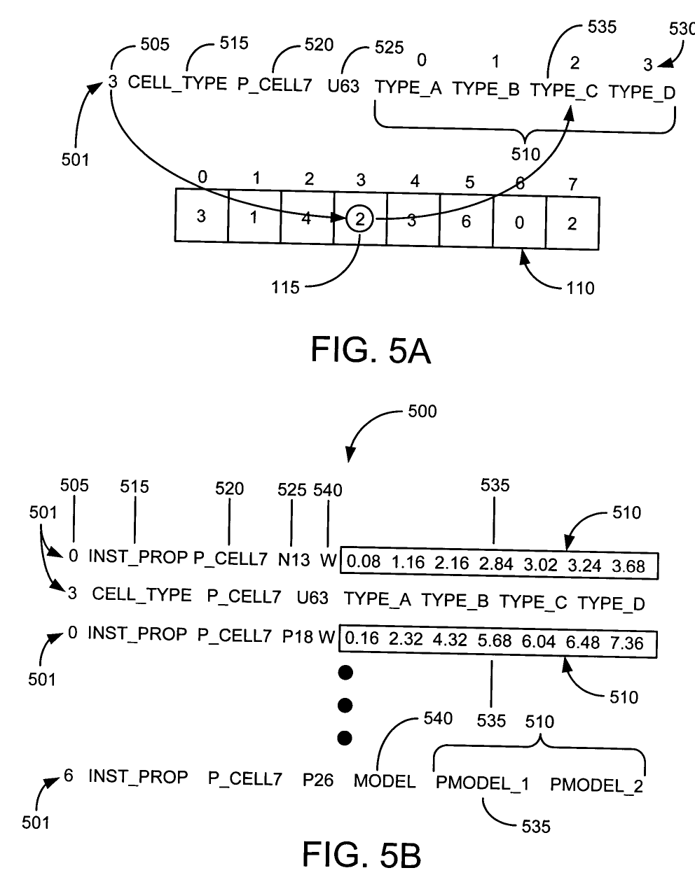

FIG. 5A is an illustration of an entry 501 in a data structure 500 (see FIG. 5B) that maps genes 115 in a chromosome 110 to characteristics of a system to be optimized in accordance with an illustrative embodiment of the invention. FIG. 5A shows one example of how the method diagramed in FIG. 4 may be implemented. The Method of FIG. 4 may be implemented in a variety of other ways, all of which are considered to be within the scope of the invention as claimed. Entry 501 comprises first index 505, set of values 510 (shown within the brace), optional keyword 515, optional parent cell identifier 520, and instance designator 525. Indices 530 for set of values 510 are shown in FIG. 5A for clarity and are not necessarily part of data structure 500. First index 505 (“3”) points to the circled gene 115 (“2”), which in turn points to particular value 535 (“TYPE_C”) in set of values 510. Such an approach provides efficient and flexible selection of settings for various characteristics of the system to be optimized.

In the particular example of FIG. 5A, optional keyword 515 (“CELL_TYPE”) informs a system accessing data structure 500 that this particular entry 501 is intended to set the cell type of a particular instance in integrated circuit 100. Optional parent cell identifier 520 (“P_CELL7”) identifies the larger block (e.g., a memory management unit) to which the applicable instance (“U63”) belongs. In this example, instance U63 is set to have cell type “TYPE_C,” where “TYPE_C” is one of a set of predefined cell types available in a circuit design library.

FIG. 5B is an illustration of a data structure 500 comprising multiple entries 501 that maps genes 115 in a chromosome 110 to characteristics of a system to be optimized in accordance with an illustrative embodiment of the invention. Each entry 501 of data structure 500 corresponds to a particular characteristic (a design choice for a specified instance) of a system to be optimized (e.g., integrated circuit 100).

The top line of data structure 500 sets the width of an NMOS transistor “N13.” Optional parameter indicator 540 (“W”) indicates that the characteristic of transistor N13 to be set is its width. The second line of data structure 500 is identical to FIG. 5A. The third line of data structure 500 sets the width of a PMOS transistor P18. Note that each value in the set of values 510 for transistor P18 is twice as large as the corresponding value in set of values 510 associated with transistor N13. Since first index 505 is the same for transistor N13 and transistor P18, however, the entries 501 associated with these two transistors map to the same gene 115 (“0”). For any given value of gene 115, the particular value 535 selected for transistor P18 will be twice as large as the particular value 535 selected for transistor N13. This example illustrates two principles of the present invention: (1) that multiple characteristics associated with one or more instances 105 may be mapped to a single gene 115 and (2) that predetermined relationships (e.g., a ratio) among the characteristics of grouped or related instances 105 may be ensured. The bottom line of data structure 500, by way of illustration, sets the transistor model for a PMOS transistor P26. If the chromosome 110 in FIG. 5A is assumed, first index 505 (“6”) points to a gene 115 whose value is zero, which ultimately selects “PMODEL_{—}1” as the transistor model for transistor P26.

Data structure 500 shown in FIG. 5B is merely one example of how the method discussed in connection with FIG. 4 may be implemented. The particular structure and arrangement of data structure 500 in FIGS. 5A and 5B is intended to be illustrative. Many other arrangements for such a lookup table are possible and are considered to be within the scope of the invention as claimed.

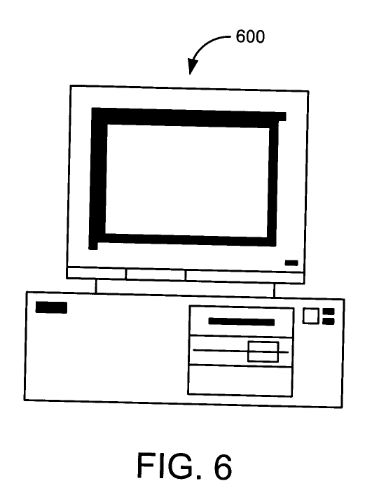

FIG. 6 is an illustration of a system for carrying out the methods of the invention in accordance with an illustrative embodiment of the invention. FIG. 6 depicts a general purpose computer 600. The methods of the invention may be programmed to execute on such a general purpose computer 600 or, alternatively, the invention may be implemented in a special-purpose (e.g., high-performance) computer, in custom hardware, or in any combination of hardware and software. In one embodiment, the invention may be carried out using a set of networked processing nodes to take advantage of parallel processing.

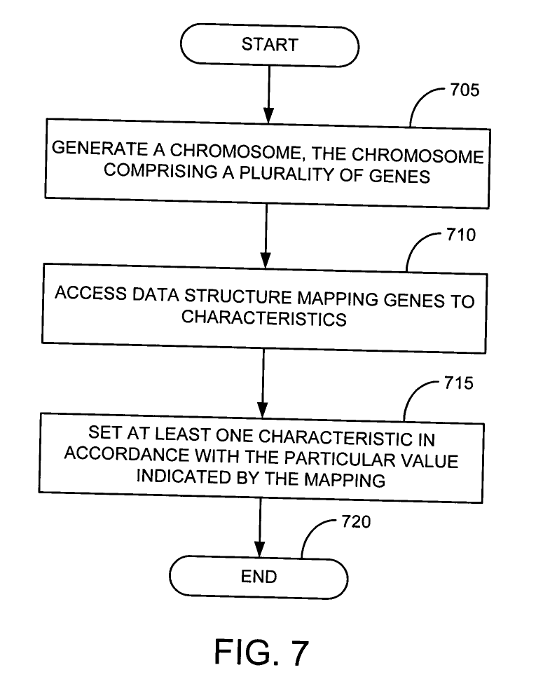

FIG. 7 is a flowchart of the operation of the system shown in FIG. 6 in accordance with an illustrative embodiment of the invention. At 705, system 600 may generate a chromosome 110, chromosome 110 comprising a plurality of genes 115. System 600 may access data structure 500 at 710. At 715, system 600 may set at least one characteristic of a system to be optimized in accordance with the particular value 535 obtained from data structure 500, as explained in connection with FIGS. 4, 5A, and 5B. The process then terminates at 720.

Program code implementing the invention may also be stored on a computer-readable storage medium. Examples of computer-readable storage media include solid-state read-only memory, magnetic disks, and optical disks. In such an implementation, the contents of the computer-readable storage medium may comprise a first code segment configured to associate with a characteristic a set of values 510 and a first index 505 and a second code segment configured to set the characteristic in accordance with the particular value 535 obtained from the corresponding entry 501 in data structure 500.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A method, in a computer-implemented optimization process based on a genetic model, for setting a characteristic of a system to be optimized, comprising:
associating with the characteristic a set of values and a first index, the first index corresponding to a gene within a chromosome, the gene comprising a second index corresponding to a particular value in the set of values; and
setting the characteristic in accordance with the particular value.

2. The method of claim 1, wherein a plurality of characteristics are associated with the same first index.

3. The method of claim 1, wherein a first characteristic and a second characteristic are associated with the same first index and, for each applicable value of the second index, the particular value in the set of values associated with the first characteristic and the particular value in the set of values associated with the second characteristic are related by a predetermined ratio.

4. The method of claim 1, wherein associating with the characteristic a set of values and a first index comprises accessing a data structure, the data structure comprising a plurality of entries, each entry corresponding to a characteristic of the system to be optimized, each entry comprising the associated first index and set of values.

5. The method of claim 1, wherein the system to be optimized comprises an integrated circuit.

6. The method of claim 5, wherein the characteristic comprises one of a cell type, a transistor model, and a transistor width.

7. A method, in a computer-implemented optimization process based on a genetic model, for mapping the characteristics of a system to be optimized to the genes of a chromosome, the method comprising:
generating a lookup table having a plurality of entries, each entry corresponding to a characteristic of the system to be optimized, each entry comprising a set of values and a first index, the first index corresponding to a gene in the chromosome, the gene comprising a second index corresponding to a particular value in the set of values.

8. The method of claim 7, wherein a plurality of entries have the same first index.

9. The method of claim 7, wherein the entries corresponding, respectively, to a first characteristic and a second characteristic have the same first index and, for each applicable value of the second index, the particular value in the first entry and the particular value in the second entry are related by a predetermined ratio.

10. The method of claim 7, wherein the system to be optimized comprises an integrated circuit.

11. The method of claim 10, wherein at least one characteristic comprises one of a cell type, a transistor model, and a transistor width.

12. A system programmed to perform the following method:
generating, in a computer-implemented process based on a genetic model, a chromosome, the chromosome comprising a plurality of genes;
accessing a data structure, the data structure comprising a plurality of entries, each entry corresponding to a characteristic of a device to be optimized, each entry comprising a set of values and a first index, the first index corresponding to a gene within the chromosome, the gene comprising a second index corresponding to a particular value in the set of values; and
setting at least one characteristic in accordance with the particular value.

13. The system of claim 12, wherein a plurality of characteristics are associated with the same first index.

14. The system of claim 12, wherein a first characteristic and a second characteristic are associated with the same first index and, for each applicable value of the second index, the particular value in the set of values associated with the first characteristic and the particular value in the set of values associated with the second characteristic are related by a predetermined ratio.

15. The system of claim 12, wherein the device to be optimized comprises an integrated circuit.

16. The system of claim 15, wherein the characteristic comprises one of a cell type, a transistor model, and a transistor width.

17. A system for optimizing a device using a computer-implemented process based on a genetic model, comprising:
means for generating a chromosome, the chromosome comprising a plurality of genes;
means for accessing a data structure, the data structure comprising a plurality of entries, each entry corresponding to a characteristic of the device to be optimized, each entry comprising a set of values and a first index, the first index corresponding to a gene within the chromosome, the gene comprising a second index corresponding to a particular value in the set of values; and
means for setting at least one characteristic in accordance with the particular value.

18. A computer-readable storage medium containing program code for setting a characteristic of a system to be optimized according to a process based on a genetic paradigm, comprising:
a first code segment configured to associate with the characteristic a set of values and a first index, the first index corresponding to a gene within a chromosome, the gene comprising a second index corresponding to a particular value in the set of values; and
a second code segment configured to set the characteristic in accordance with the particular value.

19. The computer-readable storage medium of claim 18, wherein the first code segment associates a plurality of characteristics with the same first index.

20. The computer-readable storage medium of claim 18, wherein a first characteristic and a second characteristic are associated with the same first index and, for each applicable value of the second index, the particular value in the set of values associated with the first characteristic and the particular value in the set of values associated with the second characteristic are related by a predetermined ratio.

21. The computer-readable storage medium of claim 18, wherein the first code segment associates with the characteristic a set of values and a first index by accessing a data structure, the data structure comprising a plurality of entries, each entry corresponding to a characteristic of the system to be optimized, each entry comprising the associated first index and set of values.

22. The computer-readable storage medium of claim 18, wherein the system to be optimized comprises an integrated circuit.

23. The computer-readable storage medium of claim 22, wherein the characteristic comprises one of a cell type, a transistor model, and a transistor width.
